(19) United States
(12) Patent Application Publication
(10) Pub. No.: US 2018/0222616 A1
(43) Pub. Date: Aug. 9, 2018

(54) Automated Opening Device for Plastic Shopping Bags on Carousels

(71) Applicant: Walmart Apollo, LLC, Bentonville, AR (US)

(72) Inventors: Steven Lewis, Bentonville, AR (US); Nicholaus Adam Jones, Fayetteville, AR (US); Matthew Dwain Biermann, Fayetteville, AR (US)

(21) Appl. No.: 15/880,510

(22) Filed: Jan. 25, 2018

Related U.S. Application Data
(60) Provisional application No. 62/456,661, filed on Feb. 9, 2017.

(51) Int. Cl. B65B 43/28; B65B 43/36; B65B 43/46; B25J 15/00

(52) U.S. Cl. CPC B65B 43/28; B65B 43/36; B65D 33/001; B25J 15/0085; B65B 43/465

(57) ABSTRACT

Examples of the disclosure provide a system and method for autonomously opening bags using a mechanical arm. The mechanical arm includes actuators that move the mechanical arm in response to a trigger, a gripping component that attracts a portion of the bag in response to contact with the bag using a static electric charge, a nozzle that provides an introduction of compressed air into an environment relative to the opening of the bag, and a trigger mechanism that provides the trigger to the mechanical arm such that the mechanical arm brings the gripping component into contact with the bag using the one or more actuators and provides an expulsion of a portion of the compressed air via the nozzle to open the bag.

### BACKGROUND

Placing purchased goods in plastic bags is a common activity in department stores, grocery stores, and the like. In many cases, the plastic bags are stored in an empty, flat arrangement, enabling large quantities of the plastic bags to occupy small volumes of space. However, while in an empty flat arrangement, the plastic bags can be frustrating to open manually due to a tendency of the sides of the plastic bags to stick together. Further, the opening process can become time consuming when many bags must be opened for each shopper in a checkout line, increasing the time spent by shoppers waiting in the checkout line and reducing the efficiency of the checkout process. While plastic bags provide a cost-effective tool for organizing and carrying purchased goods out of a store, it is a challenge to reduce or eliminate the frustrating task of opening them.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Aspects of the disclosure provide an autonomous bag opening device comprising a mechanical arm. The mechanical arm includes one or more actuators that move the mechanical arm in response to a trigger, a gripping component that attracts at least a portion of a bag in response to contact with the bag, a nozzle that provides an introduction of compressed air into an environment relative to an opening of the bag, and a trigger mechanism that provides a trigger to the mechanical arm such that the mechanical arm brings the gripping component into contact with at least a portion of the bag using the one or more actuators and provides an expulsion of at least a portion of the compressed air via the nozzle to open the bag.

Many of the attendant features will be more readily appreciated as the same becomes better understood by reference to the following detailed description considered in connection with the accompanying drawings.

### DESCRIPTION OF THE DRAWINGS

The present description will be better understood from the following detailed description read in light of the accompanying drawings, wherein:

FIG. 1 illustrates a block diagram of a system for autonomously opening bags according to an embodiment;

FIG. 2 illustrates a state diagram of a process of opening a bag by the system of FIG. 1 according to an embodiment;

FIG. 3 illustrates a block diagram of a system for opening bags arranged on a carousel according to an embodiment;

FIG. 4 illustrates a flow chart of a method of autonomously opening bags according to an embodiment; and

FIG. 5 illustrates a computing apparatus according to an embodiment as a functional block diagram.

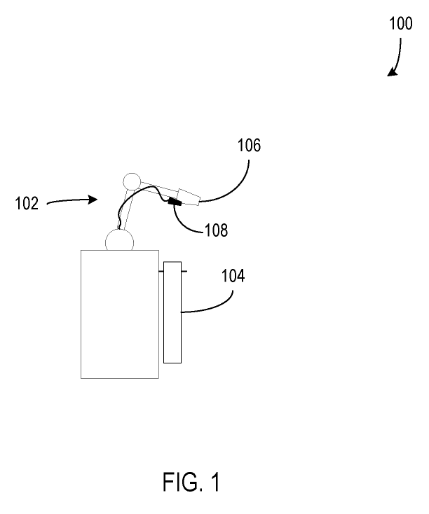

In FIGS. 1 to 5, the systems are illustrated as schematic drawings. The drawings may not be to scale. Corresponding reference characters indicate corresponding parts throughout the drawings.

### DETAILED DESCRIPTION

The detailed description provided below in connection with the appended drawings is intended as a description of a number of embodiments and is not intended to represent the only forms in which the embodiments may be constructed, implemented, or utilized. Although the embodiments may be described and illustrated herein as being implemented in devices such as a controller computing device, server, personal computer, mobile device, or the like, this is only an exemplary implementation and not a limitation. As those skilled in the art will appreciate, the present embodiments are suitable for application in a variety of different types of computing devices, for example, PCs, servers, laptop computers, tablet computers, etc.

The terms ‘computer’, ‘computing apparatus’, ‘computing device’ and the like are used herein to refer to any device with processing capability such that it can execute instructions. Those skilled in the art will realize that such processing capabilities are incorporated into many different devices and therefore the terms ‘computer’ and ‘computing apparatus’ each may include PCs, servers, laptop computers, mobile telephones (including smart phones), tablet computers, and many other devices.

Aspects of the disclosure described below are configured to autonomously open bags using a mechanical arm. The mechanical arm includes actuators that move the mechanical arm in response to a trigger, a gripping component that attracts a portion of the bag in response to contact with the bag using a static electric charge, a nozzle that provides an introduction of compressed air into an environment relative to the opening of the bag, and a trigger mechanism that provides the trigger to the mechanical arm such that the mechanical arm brings the gripping component into contact with the bag using the one or more actuators and provides an expulsion of a portion of the compressed air via the nozzle to open the bag.

Use of the mechanical arm automates the task of opening a bag for use as a receptacle of purchased goods in a checkout line, for example. Opening a bag may be a relatively simple task, but it must be done numerous times throughout the day and can become frustrating due to sides of the bag sticking together. Automating the task of opening a bag eliminates this potential frustration for employees and/or shoppers at a store, streamlines the checkout process, and reduces time spent by customers waiting in line to check out.

FIG. 1 illustrates a block diagram of a system 100 for autonomously opening bags according to an embodiment. The system 100 comprises a mechanical arm 102 that opens bag 104 using a gripping component 106 and a nozzle 108. The mechanical arm is attached to a portion of a bag holder (an item or device on which one or more bags are hung or otherwise held) and positioned in proximity to the bag 104 such that the mechanical arm 102 can reach the bag 104 to open it via processes described herein. The mechanical arm 102 further comprises at least two rigid, straight portions and at least two hinge portions, one of which is located at the base of the mechanical arm 102 and the other is located at a mid-point, or some other point between the base and the end of the mechanical arm 102, enabling the arm to hinge, bend, and/or articulate to move the gripping component 106 toward and away from the area of the bag 104. In some examples, the mechanical arm 102 includes one or more actuators that cause the mechanical arm 102 to move and/or bend at the hinges. The actuator(s) may be positioned at the base of the mechanical arm 102, in or near the hinges of the mechanical arm 102, or elsewhere along the length of the mechanical arm 102. The actuator(s) may cause the mechanical arm 102 to move electrically, hydraulically, mechanically, or the like.

It should be understood that, while mechanical arm 102 includes two straight portions and two hinges as illustrated in FIG. 1, in alternative examples, a mechanical arm may include more, fewer, or a different arrangement of straight portions, rigid portions of other shapes, hinges, and/or other articulation components.

The bag 104 is positioned on the bag holder in proximity to the mechanical arm 102. The bag holder may hold a plurality of bags arranged such that they open toward the mechanical arm 102. The bags, including bag 104, are stored in an empty, flat state, enabling a large quantity of bags to fit on the bag holder. In an example, the bags are composed of plastic and are substantially similar to plastic shopping bags typically seen in grocery stores, department stores, and the like.

The gripping component 106 is positioned at the end of the mechanical arm 102, opposite the base, such that, when the mechanical arm 102 moves toward the bag 104, the gripping component 106 is moved to come into contact with the bag 104. The gripping component 106 generates a static electric charge to attract, or “grip”, the bag 104 when it contacts the bag 104 such that, when the mechanical arm 102 moves away from the bag 104, a portion of the bag 104 is pulled with the gripping component 106, opening the bag 104 from its flat, empty position by initiating a separation between two sides of the bag to expose an interior portion of the bag. In an example, the gripping component 106 is composed of metal or a like material capable of delivering the static electric charge to the bag 104 as described. Further, the gripping component 106 may be electrically or otherwise coupled to the base of the mechanical arm 102 such that the energy necessary to produce the static electric charge can be delivered to the gripping component 106 from the base of the mechanical arm 102 where it is connected to the bag holder or other surface.

After the mechanical arm 102 has moved away from the bag 104 and the gripping component 106 has caused the bag 104 to open, the static electric charge of the gripping component 106 may be deactivated/discharged, releasing the bag 104 from the gripping component 106. As the mechanical arm 102 returns to an initial position, the bag 104 is opened but not pulled all the way up to the initial position of the gripping component 106. The discharge of the gripping mechanism 106 may occur based on a mechanical switch triggered by the position of the mechanical arm 102, passage of a predetermined time interval after activation of the static electric charge, or the like.

The nozzle 108 is also positioned at the end of the mechanical arm 102 opposite the base, near the gripping component 106. The nozzle 108 is positioned in such a way with respect to the gripping component 106 that when the movement of the mechanical arm 102 and the gripping component 106 causes the bag 104 to open, or begin opening, the nozzle 108 can blow, motivate, force, or otherwise introduce compressed air into an interior portion of the bag 104, or into the environment near the opening of the bag 104, such that the bag 104 is further caused to open and expose an interior portion of the bag. The nozzle 108 may be connected by a line to the base of the mechanical arm and the compressed air introduced by the nozzle 108 may be delivered to the nozzle 108 from the base of the mechanical arm 102 via the connecting line by an associated compressed air tank, an air compressor device, or the like. The discharge/release of the bag 104 by the gripping component 106 may be simultaneous with, or subsequent to, the introduction of the compressed air by the nozzle 108.

The mechanical arm 102 may further include a trigger mechanism that, when triggered, causes the mechanical arm 102 to open the bag 104 as described. The trigger mechanism may be triggered automatically based on a state of the bag 104, other bags, and/or the environment around the mechanical arm 102, and/or it may be triggered manually by a user, such as a clerk at a store. For instance, the trigger mechanism may include a weight sensor on the bag holder, bag location, or carousel that detects the presence of a bag in a bag location and/or the presence of items in a bag in a bag location. Detecting an empty bag by a weight sensor or other type of sensor may trigger the trigger mechanism to cause the mechanical arm 102 to open the bag 104. Alternatively, detecting a bag containing items may not trigger the trigger mechanism because a bag containing items has already been opened.

In an example, the system 100 and/or the mechanical arm 102 further include a trigger lock that controls a state of the trigger mechanism, such that the trigger mechanism may be placed in a locked or unlocked state. When locked, the trigger mechanism prevents the mechanical arm 102 from being triggered to open bag 104. When unlocked, the trigger mechanism may be triggered to cause the mechanical arm 102 to open a bag. The trigger lock may be activated and/or deactivated based on a sensed state of the system 100, a mechanical switch, a fulcrum, or the like. For instance, a bag holder on which the bags hang may be further connected to the trigger lock such that, when a weight of a non-empty bag is exerted on the bag holder, the bag holder acts as a lever on a fulcrum and exerts upward pressure on a trigger lock switch, causing the trigger mechanism to become locked.

Additionally, the system 100 may include a computing device that acts as a control mechanism for the mechanical arm 102. The trigger mechanism of the system 100 may be part of or controlled by the computing device. The computing device may be part of or otherwise coupled to the mechanical arm 102 such that the computing device is enabled to send control signals to actuators of the mechanical arm 102, which in turn may cause the mechanical arm 102 to move and/or open bag 104. Further, the computing device may send control signals that cause the gripping component 106 to activate or deactivate the static electric charge and/or cause the nozzle 108 to provide compressed air to the environment in the vicinity of the nozzle 108. The computing device may include a processor, memory, and/or computer executable instructions as described below. The computing device may be configured to control the mechanical arm 102 based on input received automatically from sensors and the like and/or manually from a user of the computing device.

Sensors may be communicatively coupled to the computing device to provide input regarding the state of the system 100. For instance, a weight sensor may detect whether a bag contains items based on the weight of the bag, an optical sensor may detect whether a bag contains items due to an opacity of the bag or other visual determination, a motion sensor may detect motion of a carousel of bag locations, or mechanical switch sensors may be tripped based on a bag being removed from a bag location. Other sensors types may include mechanical sensors, electrical sensors, accelerometers, or the like. The sensors transmit sensor data signals to the computing device, where they are processed. The computing device determines how to control the mechanical arm 102 based on the received sensor data signals.

Processing the sensor data by the computing device may include comparing the sensor input data to defined data thresholds and/or comparing current sensor input data to sensor input data received previously to monitor changes in the measurements. For instance, the computing device may include a weight sensor threshold that indicates a bag measured by the sensor is not empty when exceeded by received weight sensor input data. Alternatively, or additionally, an optical sensor may detect changes in optical sensor input data that indicate an empty bag has moved through the sensor's view and into position for opening by the mechanical arm 102.

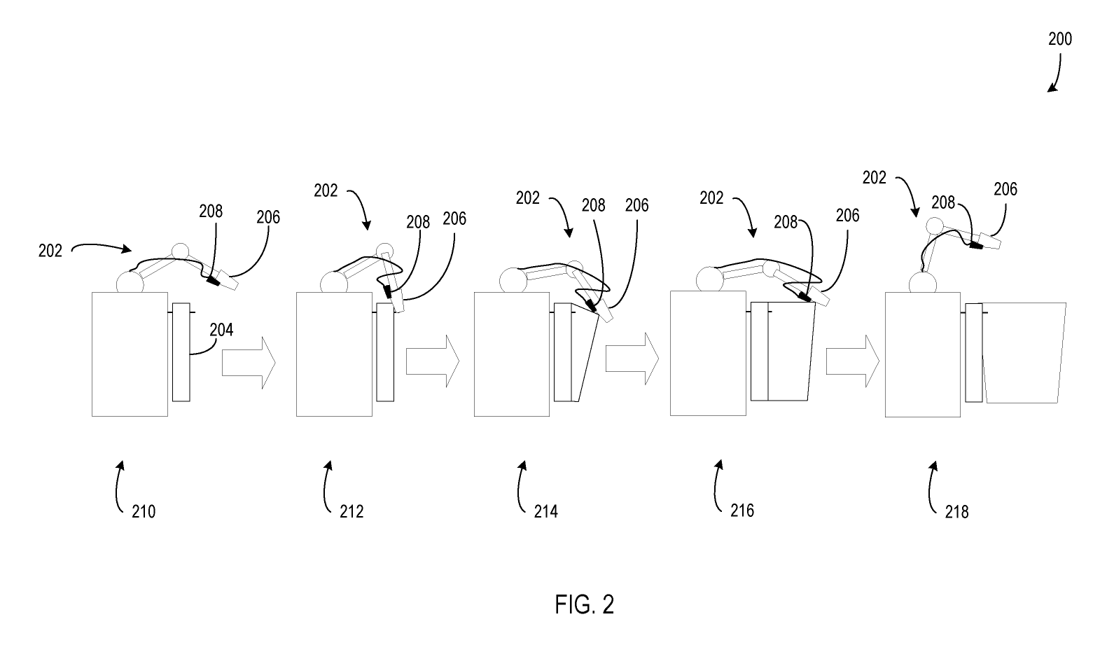

FIG. 2 illustrates a state diagram of a process 200 of opening a bag by the system of FIG. 1 according to an embodiment. The states 210-218 illustrate points during a bag opening process 200. The states are not stopping points of the process, but merely exemplary points during the process provided for visual demonstration. At state 210, the mechanical arm 202 lowers the gripping component 206 and nozzle 208 toward the bag 204. At state 212, the gripping component 206 is brought into contact with the bag 204 by the mechanical arm 202. The static electric charge of the gripping component 206 may be activated at or around state 212 to “grip” the bag 204, in some examples.

At state 214, the mechanical arm 202 moves away from the bag 204, the gripping component 206 pulling a portion of the bag 204 with the mechanical arm 202, partially opening the bag 204. At state 216, the mechanical arm 202 continues to move away from the original position of the bag 204. The gripping component 206 has pulled the gripped portion of the bag 204 away along with the mechanical arm 202. At or around state 216, the nozzle 208 introduces compressed air into the open bag to aid in opening the bag 204. The compressed air may cause portions of the bag 204, such as the bottom interior portion, to open as the air is introduced into the opening of the bag initiated by the gripping component 206. Further, at or around state 216, the gripping component 206 may be discharged to release the grip of the gripping component 206 on the bag 204. The release or discharge of the gripping component 206 may be simultaneous with, or subsequent to, the introduction of compressed air via nozzle 208, for example.

At state 218, the mechanical arm 202 has returned to an original position as illustrated in FIG. 1 and the bag 204 is open for receiving groceries, purchased goods, or the like into an interior portion of the bag.

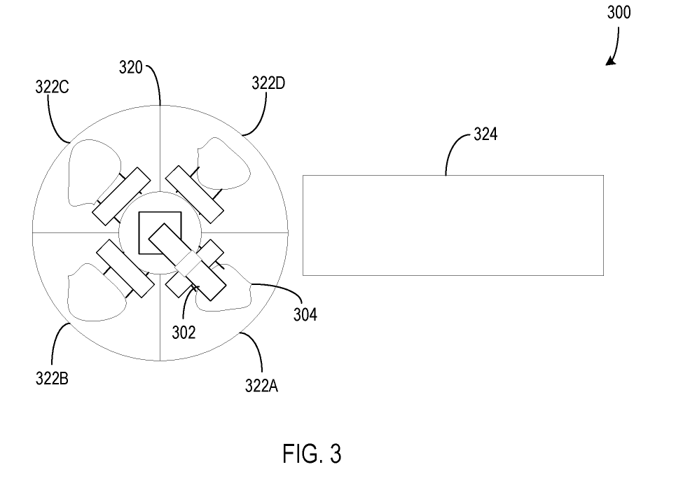

FIG. 3 illustrates a block diagram of a system 300 for opening bags arranged on a carousel 320 according to an embodiment. The mechanical arm 302 is positioned in the center of the carousel 320, which includes four bag locations 322A-322D. The mechanical arm 302 is positioned over bag location 322A in preparation for opening or having just opened bag 304 in the bag location 322A. Each of the bag locations 322A-322D includes a plurality of bags substantially similar to bag 304. The carousel 320 is positioned near a counter 324 upon which purchase activities may occur during a purchase transaction by a customer at a store, for example.

The carousel 320 may turn automatically or be turned by a clerk as bags are filled with purchased goods in each of the bag locations 322A-322D. The mechanical arm 302 may be fixed in a direction, such that, as the carousel 320 turns, the bag locations 322A-322D are moved sequentially under the mechanical arm 302. The fixed direction of the mechanical arm 302 fixes it to a plane such that the mechanical arm 302 cannot turn to access other bag locations, but the actuators of the mechanical arm 302 enable it to move the end of the arm up and down relative to the bag location under the mechanical arm 302 and/or toward and away from the bag in the bag location under the mechanical arm 302. The mechanical arm 302 may perform the bag opening process described above on a bag in each bag location as the bag location moves under the mechanical arm 302 due to rotation of the carousel 320. In an example, the fixed direction of the mechanical arm 302 is toward a position where a clerk or other employee may stand, such that the mechanical arm 302 opens a bag 304 in the bag location closest to the area where an item is ready to be inserted into a bag. The clerk may then load the recently opened bag with purchased goods.

In some examples, the carousel 320 and sensors therein and the mechanical arm 302 may interact to trigger the mechanical arm 302 to open a bag in the bag location over which the mechanical arm 302 is located. For instance, the mechanical arm 302 may be triggered to open a bag when a bag location of the carousel 320 is turned into place under the mechanical arm 302. A mechanical sensor, electrical sensor, or the like may detect a position of the carousel such that, when a bag location slides into the correct position as a result of the turning of the carousel, a signal is sent to the mechanical arm 302 that triggers the mechanical arm 302 to open the bag in the bag location. Alternatively, or additionally, rotation of the carousel 320 may be detected by motion sensors, mechanical sensors, electrical sensors, optical sensors, or the like and trigger the mechanical arm 302 to open the bag in the current bag location. In an additional example, the rotation of the carousel 320 may trip a mechanical switch which triggers the mechanical arm 302 to open the bag currently in position under the mechanical arm 302.

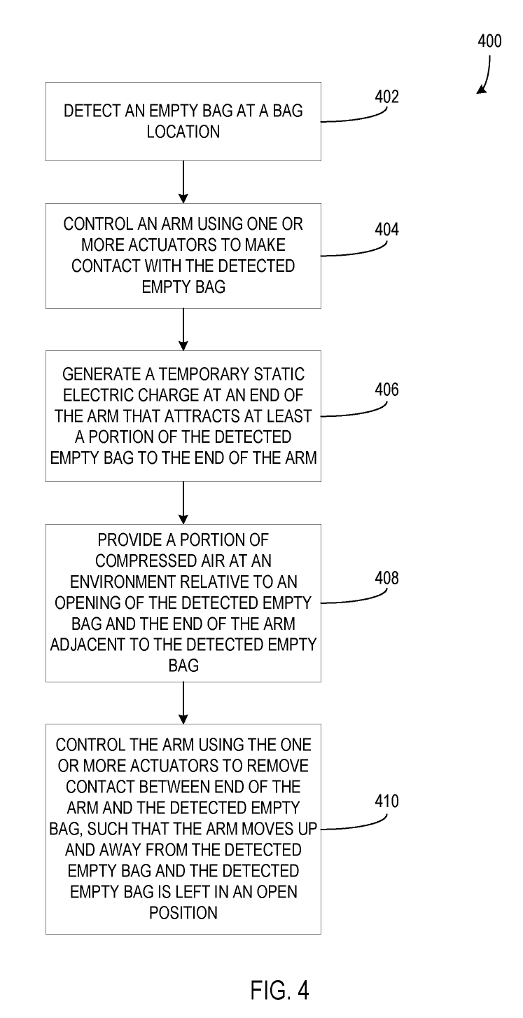

FIG. 4 illustrates a flow chart of a method 400 of automatically opening bags according to an embodiment. The process begins by detecting an empty bag at a bag location at operation 402. The detection of the empty bag may be done by sensor(s), such as a weight sensor on the bag holder, bag location, and/or carousel as described above. The sensor(s) may cause a trigger component coupled to a bag location and/or bag carousel to be triggered, which in turn may cause detection of an empty bag. In an example, rotation of a bag carousel may be sensed by sensor(s) and trigger the detection of empty bag in a bag location of the bag carousel. Alternatively, or additionally, the detection of an empty bag in a bag location may be triggered by a switch (e.g., a mechanical switch, an electronic switch, etc.) on a bag carousel associated with the bag location. The switch may be tripped automatically by motion of the bag carousel, position of the bag carousel or the like, or the switch may be tripped manually by a clerk or other user of the bag carousel.

At operation 404, an arm is controlled using one or more actuators to make contact with the detected empty bag. Contact with the empty bag may be determined by the arm moving a predefined distance toward the bag, or the arm may include sensors enabling the arm to detect contact with the bag, such as pressure sensors or other sensors that detect when the motion of the arm is resisted by the bag.

At operation 406, a temporary static electric charge is generated at an end of the arm that attracts a portion of the detected empty bag to the end of the arm. The end of the arm may include a gripping component (e.g., gripping component 106, etc.) as described above. The attraction of the bag to the end of the arm may cause the bag to open.

At operation 408, a portion of compressed air is provided at an environment relative to an opening of the detected empty bag and the end of the arm adjacent to the detected empty bag. The compressed air may be provided by a nozzle (e.g., nozzle 108, etc.) as described above.

At operation 410, the arm is controlled using the actuators to remove contact between the end of the arm and the detected empty bag such that the arm moves up and away from the detected empty bag and the detected empty bag is left in an open position. The open position may refer to an interior portion of the bag being exposed, or otherwise in a position to receive items or goods into the interior portion of the bag. The static electric charge of the end of the arm may be discharged as the arm moves away from the bag, releasing the attraction of the bag to the end of the arm.

In some examples, the method 400 may further include detecting a bag location having a bag with at least some contents and, as a result of the detection, temporarily deactivating the arm, such that the arm is not controlled to open a bag in the bag location. The deactivation of the arm may include deactivating a control mechanism coupled to actuators of the arm. The arm may be reactivated when an empty bag is once again detected in a bag location associated with the arm.

Alternatively, or in addition to the other examples described herein, examples include any combination of the following:
a mechanical arm;
one or more actuators that move a mechanical arm in response to a trigger;
a gripping component that attracts at least a portion of a bag in response to contact with the bag;
a nozzle that provides an introduction of compressed air into an environment relative to an opening of the bag;
a trigger mechanism that provides the trigger to the mechanical arm such that the mechanical arm brings the gripping component into contact with at least the portion of the bag using the one or more actuators and provides an expulsion of at least a portion of the compressed air via the nozzle to open the bag;
wherein an autonomous bag opening device is coupled to a bag carousel and the trigger mechanism is activated by a position of the bag carousel;
wherein an autonomous bag opening device is coupled to a bag carousel and the trigger mechanism is activated by a rotation of the bag carousel;
wherein a trigger mechanism further comprises a locked state and an unlocked state, and further comprising a trigger lock component that controls a state of the trigger mechanism, wherein the trigger mechanism provides the trigger in the unlocked state;
wherein a trigger lock component is a mechanical switch;
wherein a trigger lock component is a fulcrum;
wherein a gripping component generates a static electric charge to attract at least the portion of the bag in response to contact with the bag;
wherein a gripping component discharges static electric charge simultaneous with or subsequent to the introduction of compressed air via a nozzle;
wherein a gripping component discharges static electric charge at a predetermined time interval following the generating of the static electric charge;
at least one processor;
at least one sensor, communicatively coupled to at least one processor, that monitors a bagging environment and transmits sensor data to the at least one processor;
an arm having one or more actuators that move the arm in response to a trigger received from at least one processor;
a gripping component, coupled to an arm, that attracts at least a portion of a bag in response to contact with the bag;
a nozzle, coupled to an arm, that provides an introduction of compressed air into an environment relative to an opening of the bag, such that the arm brings a gripping component into contact with at least the portion of the bag using the one or more actuators in response to a trigger and provides an expulsion of at least a portion of the compressed air via the nozzle to open the bag;
wherein at least one sensor is a weight sensor that identifies whether a bag position of a bag carousel has an empty bag at said bag position;
wherein at least one sensor is an optical sensor that identifies whether a bag position of a bag carousel has an empty bag at said bag position;
wherein at least one processor receives sensor data from at least one sensor and processes the sensor data to determine whether to provide a trigger to an arm;
wherein an arm is fixed relative to one plane and wherein one or more actuators move the arm relative to one or more other planes;
detecting an empty bag at a bag location;
controlling an arm using one or more actuators to make contact with a detected empty bag;
generating a temporary static electric charge at an end of an arm that attracts at least a portion of a detected empty bag to the end of the arm;
providing a portion of compressed air at an environment relative to an opening of a detected empty bag and the end of an arm adjacent to the detected empty bag;
controlling an arm using the one or more actuators to remove contact between the end of the arm and a detected empty bag, such that the arm moves up and away from the detected empty bag and the detected empty bag is left in an open position;
wherein detecting an empty bag includes receiving a trigger from a trigger component coupled to a bag carousel;
detecting a bag location having a bag with at least some contents;
temporarily deactivating a control mechanism coupled to one or more actuators, wherein the control mechanism is reactivated in response to the detection of an empty bag at the bag location;
wherein detecting an empty bag at a bag location further comprises receiving a trigger associated with a rotation of a bag carousel;
wherein detecting an empty bag at a bag location further comprises receiving a trigger associated with at least one sensor corresponding to a bag carousel;
wherein detecting an empty bag at a bag location further comprises receiving a trigger associated with a mechanical switch coupled to a bag carousel.

In some examples, the operations illustrated in FIG. 4 may be implemented as software instructions encoded on a computer readable medium, in hardware programmed or designed to perform the operations, or both. For example, aspects of the disclosure may be implemented as a system on a chip or other circuitry including a plurality of interconnected, electrically conductive elements.

While the aspects of the disclosure have been described in terms of various examples with their associated operations, a person skilled in the art would appreciate that a combination of operations from any number of different examples is also within scope of the aspects of the disclosure.

### Exemplary Operating Environment

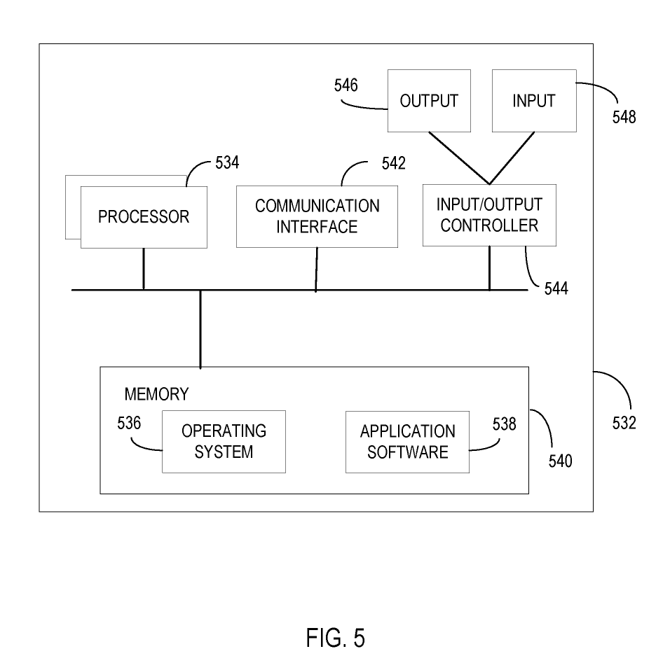

FIG. 5 illustrates a computing apparatus 532 according to an embodiment as a functional block diagram. In an embodiment, components of a computing apparatus 532 may be implemented as a part of an electronic device and/or computing device according to one or more embodiments described in this specification. The computing apparatus 532 comprises one or more processors 534 which may be microprocessors, controllers or any other suitable type of processors for processing computer executable instructions to control the operation of the electronic device. Platform software comprising an operating system 536 or any other suitable platform software may be provided on the computing apparatus 532 to enable application software 538 to be executed on the device. According to an embodiment, receiving sensor data input and, based on the received input, controlling a mechanical arm to open bags may be accomplished by software.

Computer executable instructions may be provided using any computer-readable media that are accessible by the computing apparatus 532. Computer-readable media may include, for example, computer storage media such as a memory 540 and communications media. Computer storage media, such as a memory 540, include volatile and non-volatile, removable and non-removable media implemented in any method or technology for storage of information such as computer readable instructions, data structures, program modules or the like. Computer storage media include, but are not limited to, RAM, ROM, EPROM, EEPROM, flash memory or other memory technology, CD-ROM, digital versatile disks (DVD) or other optical storage, magnetic cassettes, magnetic tape, magnetic disk storage or other magnetic storage devices, or any other non-transmission medium that can be used to store information for access by a computing apparatus. In contrast, communication media may embody computer readable instructions, data structures, program modules, or the like in a modulated data signal, such as a carrier wave, or other transport mechanism. As defined herein, computer storage media do not include communication media. Therefore, a computer storage medium should not be interpreted to be a propagating signal per se. Propagated signals per se are not examples of computer storage media. Although the computer storage medium (the memory 540) is shown within the computing apparatus 532, it will be appreciated by a person skilled in the art, that the storage may be distributed or located remotely and accessed via a network or other communication link (e.g. using a communication interface 542).

The computing apparatus 532 may comprise an input/output controller 544 configured to output information to one or more output devices 546, for example a display or a speaker, which may be separate from or integral to the electronic device. The input/output controller 544 may also be configured to receive and process an input from one or more input devices 548, for example, a sensor, a keyboard, a microphone or a touchpad. In one embodiment, the output device 546 may also act as the input device. An example of such a device may be a touch sensitive display. The input/output controller 544 may also output data to devices other than the output device, e.g. a locally connected printing device.

The functionality described herein can be performed, at least in part, by one or more hardware logic components. According to an embodiment, the computing apparatus 532 is configured by the program code when executed by the processor 534 to execute the embodiments of the operations and functionality described. Alternatively, or in addition, the functionality described herein can be performed, at least in part, by one or more hardware logic components. For example, and without limitation, illustrative types of hardware logic components that can be used include Field-programmable Gate Arrays (FPGAs), Application-specific Integrated Circuits (ASICs), Program-specific Standard Products (ASSPs), System-on-a-chip systems (SOCs), Complex Programmable Logic Devices (CPLDs), Graphics Processing Units (GPUs).

Although some of the present embodiments may be described and illustrated as being implemented in a controller computing device, client device, server device, personal computer, or the like, these are only examples of a device and not a limitation. As those skilled in the art will appreciate, the present embodiments are suitable for application in a variety of different types of devices, such as conventional computing devices, portable and mobile devices, laptop computers, tablet computers, etc.

Any range or device value given herein may be extended or altered without losing the effect sought, as will be apparent to the skilled person.

The embodiments illustrated and described herein as well as embodiments not specifically described herein but within the scope of aspects of the claims constitute exemplary means for receiving sensor data, processing sensor data, and controlling a mechanical arm to automatically open a bag based on the sensor data. The illustrated one or more processors 534 together with the computer program code stored in memory 540 constitute exemplary processing means for comparing sensor data to defined thresholds, monitoring changes in sensor data, and sending control signals to connected devices.

The order of execution or performance of the operations in examples of the disclosure illustrated and described herein is not essential, unless otherwise specified. That is, the operations may be performed in any order, unless otherwise specified, and examples of the disclosure may include additional or fewer operations than those disclosed herein. For example, it is contemplated that executing or performing a particular operation before, contemporaneously with, or after another operation is within the scope of aspects of the disclosure.

The term “comprising” is used in this specification to mean including the feature(s) or act(s) followed thereafter, without excluding the presence of one or more additional features or acts. Furthermore, when introducing elements of aspects of the disclosure or the examples thereof, the articles “a,” “an,” “the,” and “said” are intended to mean that there are one or more of the elements. The terms “comprising,” “including,” and “having” are intended to be inclusive and mean that there may be additional elements other than the listed elements. The term “exemplary” is intended to mean “an example of.” The phrase “one or more of the following: A, B, and C” means “at least one of A and/or at least one of B and/or at least one of C.”

Having described aspects of the disclosure in detail, it will be apparent that modifications and variations are possible without departing from the scope of aspects of the disclosure as defined in the appended claims. As various changes could be made in the above constructions, products, and methods without departing from the scope of aspects of the disclosure, it is intended that all matter contained in the above description and shown in the accompanying drawings shall be interpreted as illustrative and not in a limiting sense.

While the disclosure is susceptible to various modifications and alternative constructions, certain illustrated examples thereof are shown in the drawings and have been described above in detail. It should be understood, however, that there is no intention to limit the disclosure to the specific forms disclosed, but on the contrary, the intention is to cover all modifications, alternative constructions, and equivalents falling within the spirit and scope of the disclosure.

1. An autonomous bag opening device comprising:
a mechanical arm comprising:
one or more actuators that move the mechanical arm in response to a trigger;
a gripping component that attracts at least a portion of a bag in response to contact with the bag;
a nozzle that provides an introduction of compressed air into an environment relative to an opening of the bag; and
a trigger mechanism that provides the trigger to the mechanical arm such that the mechanical arm brings the gripping component into contact with at least the portion of the bag using the one or more actuators and provides an expulsion of at least a portion of the compressed air via the nozzle to open the bag.

2. The autonomous bag opening device of claim 1, wherein the autonomous bag opening device is coupled to a bag carousel and the trigger mechanism is activated by a position of the bag carousel.

3. The autonomous bag opening device of claim 1, wherein the autonomous bag opening device is coupled to a bag carousel and the trigger mechanism is activated by a rotation of the bag carousel.

4. The autonomous bag opening device of claim 1, wherein the trigger mechanism further comprises a locked state and an unlocked state, and further comprising:
a trigger lock component that controls a state of the trigger mechanism, wherein the trigger mechanism provides the trigger in the unlocked state.

5. The autonomous bag opening device of claim 4, wherein the trigger lock component is a mechanical switch.

6. The autonomous bag opening device of claim 4, wherein the trigger lock component is a fulcrum.

7. The autonomous bag opening device of claim 1, wherein the gripping component generates a static electric charge to attract at least the portion of the bag in response to contact with the bag.

8. The autonomous bag opening device of claim 7, wherein the gripping component discharges the static electric charge simultaneous with or subsequent to the introduction of the compressed air via the nozzle.

9. The autonomous bag opening device of claim 7, wherein the gripping component discharges the static electric charge at a predetermined time interval following the generating of the static electric charge.

10. An autonomous bag opening system comprising:
at least one processor;
at least one sensor, communicatively coupled to the at least one processor, that monitors a bagging environment and transmits sensor data to the at least one processor;
an arm having one or more actuators that move the arm in response to a trigger received from the at least one processor;
a gripping component, coupled to the arm, that attracts at least a portion of a bag in response to contact with the bag;
a nozzle, coupled to the arm, that provides an introduction of compressed air into an environment relative to an opening of the bag, such that the arm brings the gripping component into contact with at least the portion of the bag using the one or more actuators in response to trigger and provides an expulsion of at least a portion of the compressed air via the nozzle to open the bag.

11. The autonomous bag opening system of claim 10, wherein the at least one sensor is a weight sensor that identifies whether a bag position of a bag carousel has an empty bag at said bag position.

12. The autonomous bag opening system of claim 10, wherein the at least one sensor is an optical sensor that identifies whether a bag position of a bag carousel has an empty bag at said bag position.

13. The autonomous bag opening system of claim 10, wherein the at least one processor receives the sensor data from the at least one sensor and processes the sensor data to determine whether to provide the trigger to the arm.

14. The autonomous bag opening system of claim 10, wherein the arm is fixed relative to one plane and wherein the one or more actuators move the arm relative to one or more other planes.

15. One or more computer storage devices having computer-executable instructions stored thereon for autonomous bag opening, which, on execution by a computer, cause the computer to perform operations comprising:
detecting an empty bag at a bag location;
controlling an arm using one or more actuators to make contact with the detected empty bag;
generating a temporary static electric charge at an end of the arm that attracts at least a portion of the detected empty bag to the end of the arm;
providing a portion of compressed air at an environment relative to an opening of the detected empty bag and the end of the arm adjacent to the detected empty bag; and
controlling the arm using the one or more actuators to remove contact between end of the arm and the detected empty bag, such that the arm moves up and away from the detected empty bag and the detected empty bag is left in an open position.

16. The one or more computer storage devices of claim 15, wherein detecting the empty bag includes receiving a trigger from a trigger component coupled to a bag carousel.

17. The one or more computer storage devices of claim 15 having further computer-executable instructions comprising:
detecting a bag location having a bag with at least some contents; and
temporarily deactivating a control mechanism coupled to the one or more actuators, wherein the control mechanism is reactivated in response to the detection of the empty bag at the bag location.

18. The one or more computer storage devices of claim 15, wherein detecting the empty bag at the bag location further comprises receiving a trigger associated with a rotation of a bag carousel.

19. The one or more computer storage devices of claim 15, wherein detecting the empty bag at the bag location further comprises receiving a trigger associated with at least one sensor corresponding to a bag carousel.

20. The one or more computer storage devices of claim 15, wherein detecting the empty bag at the bag location further comprises receiving a trigger associated with a mechanical switch coupled to a bag carousel.
